(19) United States
(12) Patent Application Publication
(10) Pub. No.: US 2024/0063923 A1
(43) Pub. Date: Feb. 22, 2024

(54) SETTING A PERFORMANCE MODE OF AN RF RECEIVER FRONTEND

(71) Applicant: Microchip Technology Incorporated, Chandler, AZ (US)

(72) Inventors: Saeed Pourbagheri, Poway, CA (US); Pansop Kim, Torrance, CA (US); Rahim Bagheri, Poway, CA (US); Omid Rajaee, San Diego, CA (US); Hyunchul Kim, San Diego, CA (US); Amr Aly, Irvine, CA (US); Mohammad Mehrjoo, San Diego, CA (US); Sheng Liu, Irvine, CA (US)

(21) Appl. No.: 18/453,979

(22) Filed: Aug. 22, 2023

Related U.S. Application Data
(60) Provisional application No. 63/373,171, filed on Aug. 22, 2022.

(51) Int. Cl. H04B 17/21; H04B 1/16

(52) U.S. Cl. CPC H04B 17/21; H04B 1/16

(57) ABSTRACT

Examples relate to setting a performance mode of an RF receiver front end. An example method includes determining a power state of an input signal to an RF receiver front end; and setting a performance mode of the RF receiver front end to one of at least three distinct performance modes offered by the RF receiver front end at least partially responsive to the determined power state of the input signal.

### CROSS-REFERENCE TO RELATED APPLICATIONS

This application claims the benefit under 35 U.S.C. § 119(e) of U.S. Provisional Patent Application Ser. No. 63/373,171, filed Aug. 22, 2022, entitled “CHANGING A POWER MODE OF A RECEIVER FRONTEND TO A LOWER POWER MODE IN RESPONSE TO A RADIO FREQUENCY (RF) INPUT SIGNAL LEVEL BELOW A THRESHOLD,” the disclosure of which is hereby incorporated herein in its entirety by this reference.

### FIELD

Examples relate, generally, to receivers and radio-frequency receiver front ends. Some examples relate to setting performance of a receiver front end based on an input signal power state. In some examples, performance includes sensitivity, blocker tolerance, or both. Some examples relate to operating an RF receiver front end in a default, lower performance mode until the input signal power state indicates a higher performance mode.

### BACKGROUND

Wireless and wired receivers are used for electronic communication in a variety of operational context.

### BRIEF DESCRIPTION OF THE DRAWINGS

To easily identify the discussion of any particular element or act, the most significant digit or digits in a reference number refer to the figure number in which that element is first introduced.

FIG. 1 is a graph 100 depicting information about input signal power and performance modes for an RF receiver, in accordance with one or more examples.

FIG. 2 is a block diagram depicting an apparatus including performance modes respectively settable at least partially responsive to an input signal power state, in accordance with one or more examples.

FIG. 3 is a block diagram of an apparatus for determining performance settings, in accordance with one or more examples.

FIG. 4 is a flow diagram depicting a process to set a performance mode of an RF receiver front end based on an input signal power state, in accordance with one or more examples.

FIG. 5 is a flow diagram depicting a process for operating an RF receiver front end in a default performance mode until an input signal power state indicates changing to a different performance mode, in accordance with one or more examples.

FIG. 6 is a flow diagram depicting a process for operating an RF receiver front end in a default performance mode when an input signal power state indicates changing from a different, higher performance mode, in accordance with one or more examples.

FIG. 7 is a flow diagram depicting a process to determine an input signal power state, the input signal power state of an input signal to an RF receiver front end, in accordance with one more examples.

FIG. 8 is a flow diagram depicting a process to set a performance mode of the RF receiver front end to one of at least three distinct performance modes offered by the RF receiver front end at least partially responsive to a determined input signal power state, in accordance with one or more examples.

FIG. 9 is a block diagram depicting a signal processing chain including performance defining blocks that are settable, in accordance with one or more examples.

FIG. 10 is a block diagram depicting a signal processing chain that includes a bypass, in accordance with one or more examples.

FIG. 11 is a block diagram depicting a control register with fields that are utilized to store values of performance defining settings, in accordance with one or more examples.

FIG. 12 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

The sensitivity of a receiver is the threshold level at which the receiver reliably detects a signal. In the case of an RF receiver, sensitivity is the threshold level at which the RF receiver reliably detects an RF signal. Sensitivity defines a lowest signal strength (typically measured in decibels relative to a milliwatt (dBm)) the RF receiver should be understood to reliably detect and process. The sensitivity of an RF receiver depends on the various signal processing blocks of an RF receiver's signal processing chain, including, as non-limiting examples: filtering, amplification, and other signal processing. Sensitivity defining parameters of such operations may be set and changed, including, without limitation, during operation, and so the sensitivity of an RF receiver may be set or change, including, without limitation, during operation. A specific configuration for a sensitivity setting is referred to herein as a “sensitivity mode” of an RF receiver. Example RF receivers discussed herein may offer multiple sensitivity modes, respectively associated with predetermined sensitivity settings.

“Blocker power” is a magnitude of interference by an interfering signal (a signal other than a target signal/signal-of-interest), such interfering signal also referred to herein as a “blocker signal.” Interference is the extent to which a blocker signal reduces reception of a target signal. In the context of an RF receiver, “blocker tolerance” refers to the magnitude of interference an RF receiver can reliably tolerate (e.g., filter out, without limitation) without significant degradation of performance. Blocker tolerance is at least partially based on a filter bandwidth of the RF receiver, and so filtering bandwidth is a non-limiting example of a blocker tolerance defining parameter. A specific configuration for a blocker tolerance is referred to herein as a “block tolerance mode” of an RF receiver. Example RF receivers discussed herein may offer multiple blocker tolerance modes.

Blocker tolerance and sensitivity of an RF receiver are collectively referred to herein as “performance” of the RF receiver, and blocker tolerance modes and sensitivity modes are collectively referred to herein as “performance modes.”

A typical radio frequency (RF) receiver (such as an RF receiver used for BLUETOOTH® communication, without limitation) is configured to operate at its highest sensitivity, blocker tolerance, or both across a wide input signal power range. However, in practical scenarios, an RF receiver encounters a narrower band of input signal levels. By assigning a probability curves to the entire operating range of an RF receiver, it is evident that much of the heightened sensitivity, blocker tolerance, or both is overdesigned for the input signal levels commonly encountered.

The probability curve for an RF receiver exhibits a prominent peak corresponding to the narrow band of commonly encountered input signal levels. The probability tapers off sharply on either side of the peak. The probability curve exhibits the prominent peak at moderate input signal levels that do not demand the highest performance setting (e.g., sensitivity setting, blocker tolerance setting, or both, without limitation) so a moderate performance setting should, in theory, be sufficient. Adopting the moderate performance setting meets the input signal's requirements and uses less power than the highest performance setting.

One or more examples relate to an RF receiver front end, and RF receiver including the same, that operates at a moderate performance setting, optionally by default, only switching to a higher or highest performance setting when the input signal necessitates it, and switching to a lower or lowest performance setting when the input signal permits it. “Default” refers to a preset that the RF receiver front end will use in the absence of any other instructions. In one or more examples, a default performance mode setting may be utilized when a device is first powered on or when no other specific performance setting has been selected (e.g., by a user or an application layer, without limitation).

While some example RF receiver front ends discussed herein offer three distinct performance modes (e.g., lowest, moderate, and highest, without limitation), the scope of this disclosure is not limited to offering only three sensitivity modes, and offering more than three modes is specifically contemplated. Further, sensitivity adjustment is not limited to three or more distinct modes. One or more examples relate to an RF receiver that offers continuous sensitivity adjustment, adjusting seamlessly in response to an input signal power state.

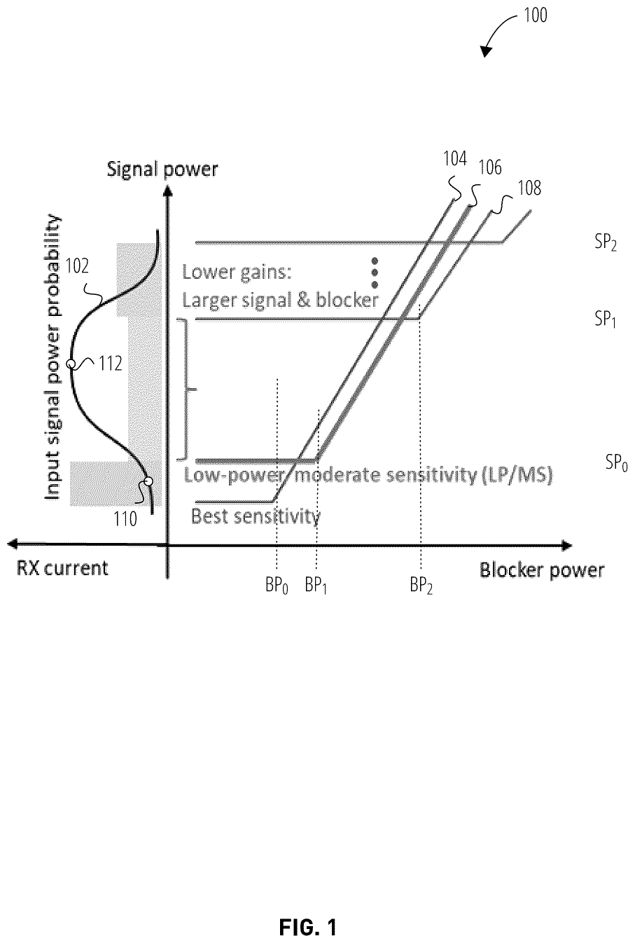

FIG. 1 is a graph 100 depicting information about input signal power and sensitivity modes for an RF receiver, in accordance with one or more examples. The graph 100 includes an x-axis, a y-axis, a line 102, a line 104, a line 106, and a line 108.

The y-axis of the graph corresponds to input signal power, with values of input signal level increasing from the bottom toward the top of the y-axis. In this example, the input signal power range of the RF receiver (also referred to as the “dynamic range” of the RF receiver) is defined between SPₒ and SP₂, signal power is expressed in decibels relative to a milliwatt (dBm). Markers for several intermediate signal power levels are depicted on the right side of the page, namely, dBm₁ and dBm₂, and are discussed below.

The positive going side of the x-axis corresponds to blocker power, increasing from left to right. Sub-ranges of blocker power that the RF receiver can tolerate in specific performance modes (represented by line 104, line 106 and line 108, discussed below) are also identified. “Blocker power” is a magnitude of interference by an interfering signal (a signal other than a target signal). Interference is the extent to which an interfering signal reduces reception of a target signal. In the context of an RF receiver frontend, “blocker power” is used to refer to the magnitude of interference the RF receiver frontend can reliably tolerate (e.g., filter out, without limitation) without significant degradation of performance. The negative going side of the x-axis corresponds to receiver (RX) current, increasing from right to left. Rectangular boxes are depicted adjacent to the y-axis, each vertically aligned with the negative going side of the x-axis to indicate the power consumption (here, given as current consumption) for a respective performance mode.

Line 102 is a curve that represents the probability that the RF receiver frontend (or RF receiver more generally) will encounter a given input signal level on the y-axis. For a given input signal level on the y-axis, the point on line 102 aligned horizontally with the given input signal level corresponds to a probability that the given input signal level will be encountered. The greater the distance between the point on line 102 and the y-axis, the higher the probability. For example, point 110 is closer to the y-axis than point 112, so the probability curve represented by line 102 indicates that the probability of encountering the input signal level associated with point 110 is lower (much lower in this example) than the probability of encountering the input signal level associated with point 112.

While only a single probability curve is depicted by FIG. 1, probability curves may be obtained that represent the probability of encountering a target signal for given signal levels, and probability curves may be obtained that represent the probability of encountering blocker signals for given signal levels. The probability curve represented by line 102 is a probability of encountering a target signal for given signal levels.

Line 104, line 106 and line 108 represent signal power ranges and blocker power ranges of three example distinct performance modes of an RF receiver front end. As discussed below, respective performance modes may be characterized by differing filtering bandwidth, gain, DC bias current levels, and clock rates, which are chosen to balance sensitivity, block tolerance, or both, against power consumption.

Line 104 represents a performance mode suitable for a target signal power less than signal power SP 2 for which a highest sensitivity setting meets the requirement of the target signal, and provide suitable blocker tolerance for blocker power less than block power BP₀. In this example, line 104 indicates that the highest sensitivity setting will meet the requirements of the entire dynamic range of the RF receiver front end, and provide suitable blocker tolerance at block power BP₀ and lower.

As mentioned above, not all input signal levels demand the highest sensitivity or blocker tolerance. Line 106 represents a performance mode suitable for a signal power lower than signal power SP 2 and greater than signal power SP₀, and provide suitable blocker tolerance for blocker power lower than blocker power BP₁. In this example, the sensitivity setting associated with the performance mode represented by line 106 will meet the requirements of a target signal having signal power that is greater than signal power SP₀. Line 108 represents a performance mode suitable for a signal power less than signal power SP₂ and greater than signal power SP₁, and provide suitable blocker tolerance for blocker power less than BP₂. In this example, the sensitivity setting associated with the mode represented by line 108 will meet the requirements of a target signal that has a signal power greater than signal power SP₁.

The dynamic range of the RF receiver front end is subdivided into specific (distinct) signal power sub-ranges or ‘power states’ of the target signal. Respective power states correspond to respective performance modes. In one or more examples, performance modes may be associated with sensitivity modes, blocker tolerance modes, or both sensitivity modes and blocker tolerance modes. A sensitivity mode may be associated with a sensitivity setting. A blocker tolerance mode may be associated with a blocker tolerance setting. A performance setting may be associated with a sensitivity setting, blocker tolerance setting, or both a sensitivity setting and a blocker tolerance setting. A performance mode should reliably provide an associated performance setting. A sensitivity setting associated with a performance mode may be determined based on the highest sensitivity demanded for the range of target signal power levels within a power state or power states for which the sensitivity mode is utilized. A blocker tolerance setting associated with a performance mode may be determined based on a highest blocker tolerance demanded for the range of blocker signal power levels within a power state or power states for which blocker tolerance mode is utilized.

In one or more examples, input signal power sub-ranges (e.g., target signal power sub-ranges and blocker signal power sub-ranges, without limitation) may be determined at least partially based on the probability of the RF receiver front end encountering signals within these sub-ranges. The probability may be defined by a probability curve such as the probability curve represented by line 102, without limitation. Any suitable technique may be utilized to determine the probability curve, including, as a non-limiting example, by observing power states of input signals in environments representative of operational conditions for which an RF receiver front end may be used; or utilizing public or private database that include information about input signal power levels (e.g., target signal power levels and blocker signal power levels, without limitation) that may be encountered in various environments, and that include probability information or information based on which probability information may be determined.

In one or more examples, thresholds defining the input signal power sub-ranges and, thus, power states, may be determined utilizing the probability information and other relevant information or criteria. As a non-limiting example, a cost function may be utilized that aims to minimize the potential cost of failing to meet demanded sensitivity and maximize the potential reward of reducing power consumption by the RF receiver front end. Such a cost function may be weighted by the probability of encountering signals within a respective sub-range. In this manner, the values of the thresholds defining the power states may be influenced by probability information. Determining the values of thresholds at least partially based on probability information (such as the probability of encountering input signals (target signals, blocker signals, or both) having specific power levels, without limitation) or may be referred to herein as a “probabilistic-based determination” and such a threshold may be referred to herein as a “probabilistic-based threshold.”

As a further non-limiting example, a calibration process may be utilized that sweeps a range of input signal powers (e.g., corresponding to a dynamic range of the RF receiver front end) for respective performance modes (sensitivity modes, blocker tolerance modes, or both) offered by an RF receiver front end, observes the error rate exhibited for range of input signal powers for respective performance modes ands sets the thresholds so that the lowest error rates are exhibited for the sub-range of input power levels associated with respective performance modes and error rate peaks at transitions between performance modes are reduced or eliminated (e.g., negligible or not present, without limitation).

In one or more examples, various operational conditions may influence one or more of: sensitivity demanded by an input signal, blocker tolerance demanded by an input signal, range of input signal power levels for which a given performance mode is sufficient, or probability of encountering a specific input signal power level. The probability of encountering a specific input signal power level may include, as non-limiting examples, the probability of encountering a target signal having the specific power level, the probability of encountering a blocker signal having a specific blocker power, or both.

Non-limiting examples of operational conditions include modes offered by the RF receiver front end other than the performance modes discussed herein and environmental conditions. Environmental conditions include, without limitation, ambient temperature, altitude (e.g., atmospheric pressure affects propagation characteristics of RF signals in air, without limitation), humidity (e.g., humidity levels may cause signal attenuation, without limitation), terrain and physical obstruction (e.g., buildings, mountains, trees, without limitation, that cause, e.g., reflection of RF signals, diffraction of RF signals, absorption of RF signals, without limitation), presence of blocker signals (e.g., environments saturated with RF sources, without limitation), crowded (e.g., many transmitters, without limitation) frequency bands, distance of a receiver from a transmitter, dynamic range of input signals (e.g., a mix of strong and weak input signals, without limitation), mobility of an RF receiver or device including the RF receiver front end, atmospheric conditions (e.g., weather, without limitation), or combinations and subcombinations thereof, without limitation.

Operational conditions may be indicated via a variety of means, such as via a global setting utilized to set, indicate, or both, other modes at the RF receiver front end (modes other than performance modes discussed above), or via an environmental status, without limitation. In one or more examples, a global setting may be set at an application layer of a receiver or device including the same. The global setting may be set by a user, based on an environmental status, or both, without limitation. Non-limiting examples of other modes of the RF receiver front end set via global settings include: a short-range mode, a long-range mode, a low-power mode, a high-power mode, or a blocker-tolerant mode. A “short-range mode” is a mode of operation specifically designed for receiving signals over a relatively shorter distance (e.g., for specific applications that involve receiving signals over a relatively shorter distance, without limitation). A “long-range mode” is a mode of operation specifically designed for receiving signals over a relatively longer distance (e.g., for a specific applications that involve receiving signals over a relatively longer distance, without limitation). A “low-power mode” is a mode of operation specifically designed to consume a relatively lower amount (e.g., lowest amount, without limitation) of power (e.g., for specific applications where power resources are limited, extending battery life of a device is a priority, or maintaining a device's operational longevity is a priority, or a combination or subcombination thereof, without limitation). A “high-power mode” is a mode of operation specifically designed to offer a highest sensitivity (e.g., for specific applications where sensitivity is a priority, without limitation). A “blocker tolerance mode” is a mode of operation specifically designed to offer highest blocker tolerance (e.g., for specific applications where blocker tolerance is a priority, without limitation).

In one or more examples, environmental status is information about one or more environmental conditions. Such information may include a value representative of an environmental condition, an indication of environmental condition, or statistical information, without limitation. Non-limiting examples of values representative of an environmental condition include: a temperature value, a humidity value, an altitude value, a distance value. Non-limiting examples of indications of environmental conditions include indications generated by logic circuits that determine (or detect existence) of specific environmental conditions, such as temperature, altitude, humidity, frequency band crowding, or presence of physical obstruction, greater than predetermined thresholds, without limitation, or indications set by users to indicate predetermined environmental conditions (whether or not such environmental conditions actually exist), such as temperature, altitude, humidity, frequency band crowding, or presence of physical obstruction, greater than predetermined thresholds.

Statistical information is information about, or useful for determining, the effect of an environmental condition (or cumulative effects of multiple environmental conditions) on transmitted RF signals, on reception of RF signals, or both. As a non-limiting example, statistical information may include information about, or useful for determining, the noisiness of an environment or suitability of an environment for transmission of RF signals, reception of RF signals, or both, at any frequency, at a specific frequency, or in a specific frequency range or frequency band. Statistical information may be provided by a user or determined dynamically (e.g., by a digital signal processor (DSP) of the RF receiver front end (e.g., a DSP that implements an automatic radio controller (discussed below) or other DSP, without limitation) or RF receiver or device including the same, without limitation). Non-limiting examples of statistical information include: Packet Error Rate (PER), Received Signal Strength Indicator (RSSI), Interference Level Frequency Range A, Interference Level Frequency Range B, or combinations and subcombinations thereof. Range A and Range B are different, predetermined frequency ranges. Determining interference over fewer or more than two frequency ranges does not exceed the scope of this disclosure.

In one or more examples, various parameters utilized to determine power states, thresholds, and sensitivity settings may be at least partially based on operational conditions of the RF receiver front end, including global settings or environmental status discussed above.

As non-limiting examples, one or more of: an input signal power range of the RF receiver front end, a probability curve, a demanded sensitivity for given power levels, and a demanded blocker tolerance may be at least partially based on a set of predetermined operational conditions of the RF receiver front end.

As a non-limiting example, indicated operational conditions may be associated with a scenario where lower or higher sensitivity or blocker tolerance is demanded than average operational conditions. Thus, in order to account for the higher probability of encountering signals that demand higher sensitivity or blocker tolerance, the peak exhibited by a probability curve utilized to determine thresholds, sub-ranges, power states, sensitivity settings, and blocker tolerance settings may be shifted down or widened relative to a probability curve that represents average operational conditions.

In one or more examples, respective sets of parameters, such as thresholds, sub-ranges, power states, sensitivity settings, and blocker tolerance settings, without limitation, may be determined for respective ones of the set of predetermined operational conditions of the RF receiver front end. These respective sets of parameters and their association with respective predetermined operational conditions of the RF receiver front end may be stored, e.g., in a non-volatile memory. Specific ones of the respective sets of parameters may be referenced at least partially based on an indication of operational condition, input signal power level, or both. A set of parameters may be selected that is associated with the indication of operational condition. The information in the selected set of parameters may be utilized to determine an input signal power state, a sensitivity setting, or a blocker tolerance setting, as discussed herein.

One or more examples relate to an RF receiver front end that offers at least three performance modes. The three performance mode provide different performance settings, including different sensitivity settings, blocker tolerance settings, or both. The RF receiver front end may operate (optionally by default) at a performance mode lower (in terms of performance settings) than a highest performance mode offered by the RF receiver front end. In one or more examples, the RF receiver front end sets the performance mode at least partially responsive to a power state of an input signal to the RF receiver front end. For example, the RF receiver front end changes to a higher performance mode (i.e., that offers higher sensitivity, higher blocker tolerance, or both, than a current performance mode, without limitation) in response to a power state of the input signal indicating it, and changes to a lower performance mode (i.e., that offers lower sensitivity, lower blocker tolerance, or both, than a current performance mode, without limitation) in response to a power state of the input signal indicating it.

A logic circuit determines the power state of the input signal and sets the performance mode of the RF receiver front end at least partially responsive to the determined input signal power state. In one or more examples, the logic circuit determines the input signal power state and dynamically determines a performance setting (e.g., a sensitivity setting, a blocker tolerance setting, or both, without limitation) at least partially based on the determined input signal power state. The logic circuit provides the performance setting to an automatic radio controller. The automatic radio controller determines values of parameters that define the sensitivity, blocker tolerance, or both of the RF receiver according to the performance setting, and provides the performance defining parameters to the signal processing chain of the RF receiver to set the performance mode.

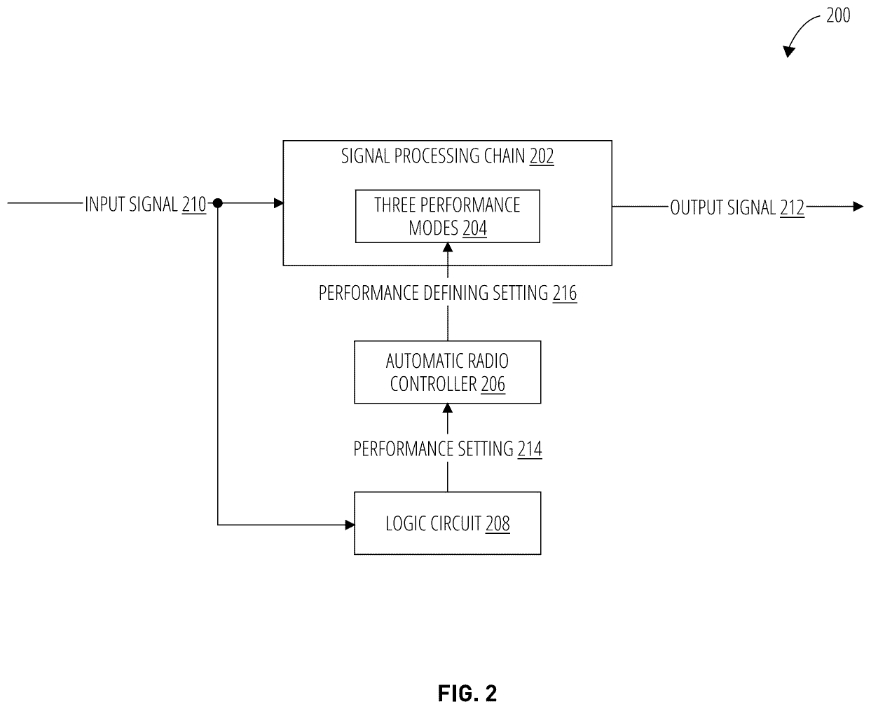

FIG. 2 is a block diagram depicting an apparatus 200 including performance modes respectively settable at least partially responsive to an input signal power state, in accordance with one or more examples. Apparatus 200 may also be referred to herein as an RF receiver front end 200.

Apparatus 200 includes signal processing chain 202, automatic radio controller 206 and logic circuit 208.

Signal processing chain 202 is a series of signal processing blocks that converts input signal 210 into an output signal 212 having a form suitable for further processing or output. Input signal 210 may include a target signal and may optionally include a blocker signal.

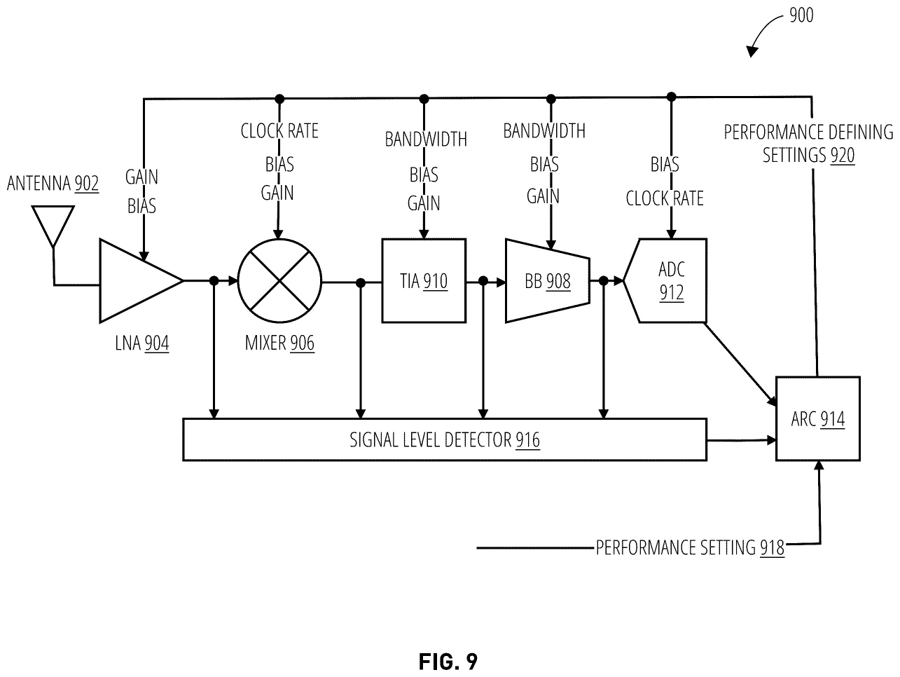

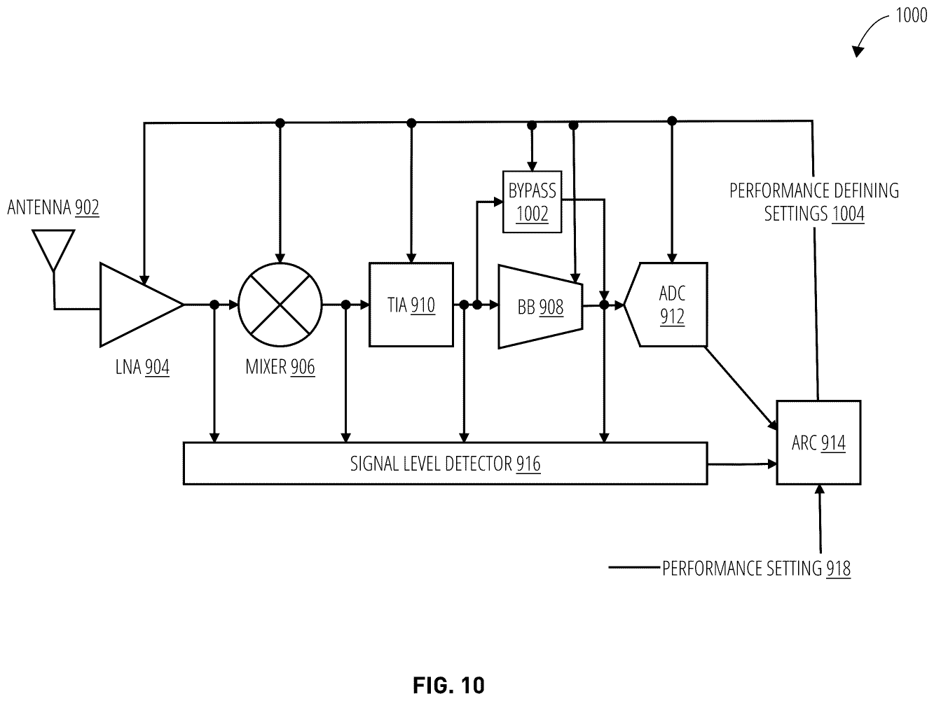

The specific signal processing blocks of signal processing chain 202 may be chosen, as a non-limiting example, at least partially based on specific operational conditions. Signal processing chain 202 includes, as a non-limiting example, the signal processing blocks depicted in FIG. 9 and FIG. 10. Signal processing chain 202 may exhibit at least three, distinct performance modes 204 responsive to performance defining setting 216, and an RF receiver front end 200, and RF receiver including the same, may be understood to offer the at least three distinct performance modes 204 that signal processing chain 202 may exhibit. Respective performance modes offer respective sensitivity settings, blocker tolerance, or both sensitivity settings and blocker tolerance.

Automatic radio controller 206 is a logic circuit, or software, or a combination thereof, that determines performance defining setting 216 for signal processing chain 202. Generally speaking, automatic radio controller 206 determines respective performance defining setting 216 for respective blocks of signal processing chain 202 to balance performance (e.g., sensitivity, blocker tolerance, or both, without limitation) and power consumption. Automatic radio controller 206 observes the performance of signal processing chain 202 and tries to match the observed performance to a target performance via control of various settings of signal processing chain 202 or blocks thereof through performance defining setting 216. In one or more examples, a target performance utilized by the automatic radio controller 206 to determine performance defining setting 216 is at least partially based on performance setting 214 provided by logic circuit 208. Performance defining setting 216 may include one or more of: gain, DC bias current, filter bandwidth, or clock-rate.

Logic circuit 208 receives input signal 210 and specifies performance setting 214 at least partially responsive thereto. Logic circuit 208 determines an input signal power state of the input signal 210 and determines the performance setting 214 at least partially based on the determined input signal power state. Logic circuit 208 specifies a performance mode of the three distinct performance modes by providing performance setting 214, which corresponds to one of the three distinct performance modes at least partially responsive to an input signal power state.

As discussed above, determined input signal power states of input signal 210 may correspond to distinct, input signal power sub-ranges. For example, a first input signal power sub-range may include input signal levels that demand the highest sensitivity setting, lowest blocker tolerance setting, or both, a second input signal power sub-range may include input signal levels that demand a moderate sensitivity setting, blocker tolerance setting, or both, and a third input signal power sub-range may include input signal levels that demand a lowest sensitivity setting, highest blocker tolerance setting, or both. Information about input signal power states, input signal power sub-ranges, thresholds associated with these sub-ranges, and associations with performance settings that correspond to performance modes may be stored in a memory of logic circuit 208 (memory not depicted) or configured at logic circuit 208 (e.g., implemented in combinational logic circuits of logic circuit 208). In one or more examples, information about performance settings and performance modes stored in a memory of logic circuit 208 or configured at logic circuit 208, as the case may be, may include information about sensitivity settings that correspond to sensitivity modes of performance modes, information about blocker tolerance settings that correspond to blocker tolerance modes of performance modes, or information about both sensitivity settings and blocker tolerance settings that correspond to performance modes.

Values for performance setting pre-associated with specific power states of input signal 210 may be provided at logic circuit 208. As non-limiting examples, the pre-association may be in the form of a look-up-table (LUT), rules engine, or function that relates values of performance settings to input signal power states.

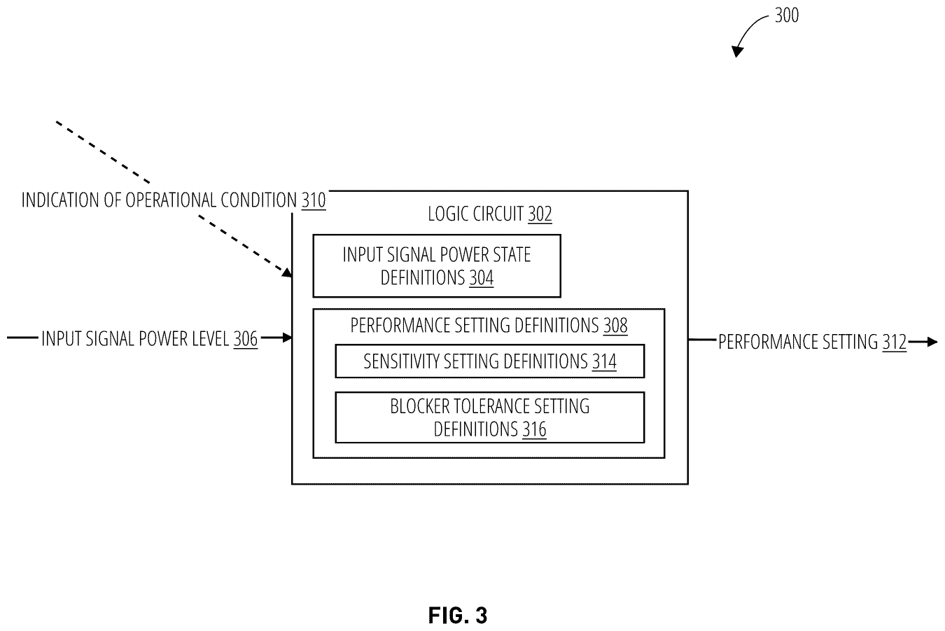

FIG. 3 is a block diagram of an apparatus 300 for determining performance settings, in accordance with one or more examples. Logic circuit 302 is a non-limiting example of a logic circuit 208 of FIG. 2.

Logic circuit 302 includes input signal power state definitions 304 and performance setting definitions 308. Input signal power state definitions 304 includes the conditions or criteria for determining an input signal power state based on input signal power level 306, discussed herein. Input signal power state definitions 304 may include one or more probabilistic-based thresholds discussed herein.

Performance setting definitions 308 includes sensitivity setting definitions 314, blocker tolerance setting definitions 316, and associations of respective performance settings (or modes) with respective input signal power states. Sensitivity setting definitions 314 includes sensitivity settings for respective sensitivity modes of respective performance modes of the RF receiver front end, and further includes associations of the respective sensitivity modes with respective input signal power states included in the input signal power state definitions 304. Blocker tolerance setting definitions 316 includes blocker tolerance settings for respective blocker tolerance modes of respective performance mode of an RF receiver front end, and further includes associations of respective blocker tolerance modes with respective input signal power states.

In one or more examples, logic circuit 302 determines an input signal power state based on input signal power level 306 and input signal power state definitions 304, and determines a performance setting 312 at least partially based on a determined input signal power state and performance setting definitions 308.

As discussed above, operational conditions may influence input signal power states and respective associated performance settings. In one or more examples, logic circuit 302 optionally receives indication of operational condition 310 which includes information about one or more operational conditions discussed above. In one or more examples, indication of operational condition 310 may be indicative of, or include indications of, a global setting or an environmental status. In one or more examples, the source of an indication of operational condition 310 may be an application layer or a DSP of the RF receiver front end or RF receiver including the same, without limitation. In one or more examples, indication of operational condition 310 may be indicative of, or include indications of, a power-on, power-on reset, or reset.

Input signal power state definitions 304 may include one or more sets of input signal power state definitions that are associated with respective one or more predetermined operational conditions. Definitions may include information about power states, input signal power levels associated with power states, and thresholds respectively associated with a first set of input signal power definitions associated with a first one of the operational conditions may be different than those associated with a second set of input signal power definitions associated with a second one of the operational conditions. Performance setting definitions 308 may include one or more sets of performance setting definitions that are respectively associated with one or more operational conditions. The performance settings and associated power states in a first set of performance setting definitions 308 associated with a first operational conditions may be different than those in a second set of performance setting definitions 308 associated with a second operational conditions.

In one or more examples, logic circuit 302 selects one of the sets of input signal power state definitions 304 and one of the sets of sensitivity setting definitions 314 at least partially based on the indication of operational condition 310, and determines an input signal power state and a performance setting 312 at least partially based on the selected sets.

Notably, provision of indication of operational condition 310 to, or utilization of indication of operational condition 310 by logic circuit 302 is optional. In one or more examples, logic circuit 302 may determine performance setting 312 with, or without, consideration of operational conditions. As a non-limiting example, an operational condition might include a high sensitivity or blocker tolerance mode set at an application layer by a global setting, nevertheless, logic circuit 302 may determine performance setting 312 that corresponds to a moderate performance mode at power on as a default setting.

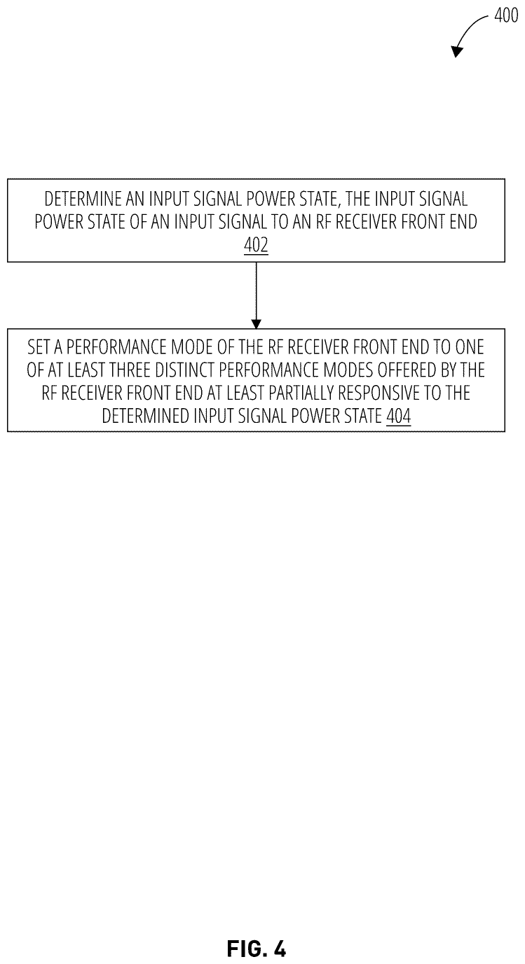

FIG. 4 is a flow diagram depicting a process 400 to set a performance mode of an RF receiver front end at least partially responsive to an input signal power state, in accordance with one or more examples. Some or a totality of operations of process 400 may be performed, as a non-limiting example, by apparatus 200 or apparatus 300.

Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

In one or more examples, process 400 includes determining an input signal power state, the input signal power state of an input signal to an RF receiver front end at operation 402. An input signal may include a target signal, a blocker signal, or both, without limitation.

In one or more examples, process 400 includes setting a performance mode of the RF receiver front end to one of at least three distinct performance modes offered by the RF receiver front end at least partially responsive to the determined input signal power state at operation 404.

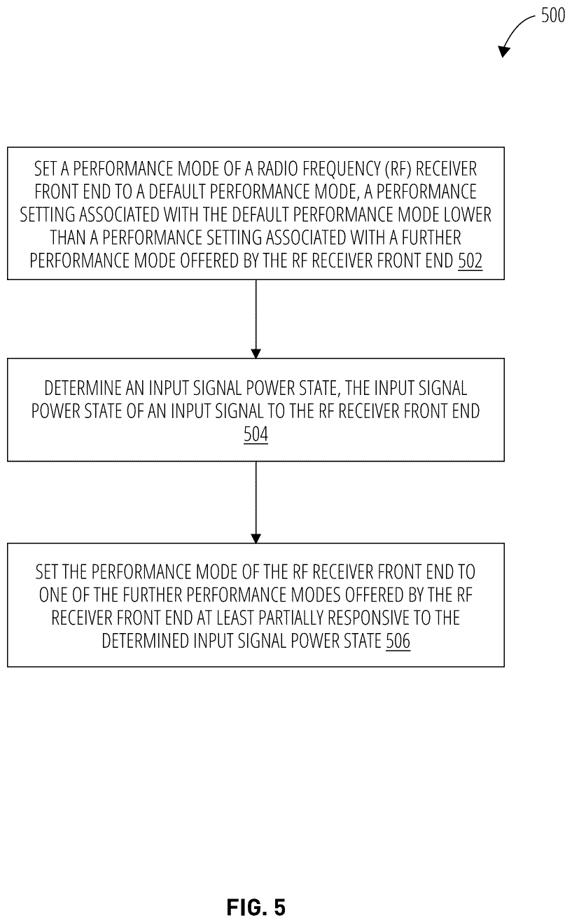

FIG. 5 is a flow diagram depicting a process 500 for operating an RF receiver front end in a default performance mode until an input signal power state indicates changing to a different performance mode, in accordance with one or more examples. Some or a totality of operations of process 500 may be performed, as a non-limiting example, by apparatus 200 or apparatus 300.

Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

In one or more examples, process 500 includes setting a performance mode of a radio frequency (RF) receiver front end to a default performance mode, at operation 502. A performance setting associated with the default performance mode is lower than a performance setting associated with a further performance mode offered by the RF receiver front end. In one or more examples, further performance modes offered by the RF receiver front end may include a performance mode associated with a higher performance setting than the default performance mode, and a may include a performance mode associated with a lower performance setting than the default performance mode. In one or more examples, process 500 may set the performance mode of the RF receiver front end to the default performance mode at least partially responsive to an indication of power-on, power-on reset, or reset. In one or more examples, process 500 may set the performance mode of the RF receiver front end to the default performance mode at least partially responsive to both: an indication of power-on, power-on reset, or reset, and a determination of no instructions (e.g., an absence of instructions, without limitation) to use a specific performance mode or a performance setting. In one or more examples, process 500 may set the performance mode of the RF receiver front end to the default performance mode regardless of an instruction to use a higher performance mode. In one or more examples, process 500 may set the performance mode of the RF receiver front end to the default performance mode responsive to an indication of power-on, power-on reset, or reset, regardless of an instruction to use a higher performance mode or an indication of an operational condition associated with a higher performance setting.

In one or more examples, process 500 includes determining an input signal power state, the input signal power state of an input signal to the RF receiver front end at operation 504. An input signal may include a target signal, a blocker signal, or both, without limitation.

In one or more examples, process 500 includes setting the performance mode of the RF receiver front end to one of the further performance modes offered by the RF receiver front end at least partially responsive to the determined input signal power state at operation 506. In one or more examples, the one of the further performance modes offered by the RF receiver front end may be a higher performance mode, i.e., associated with a higher performance setting than the performance setting associated with the default performance mode.

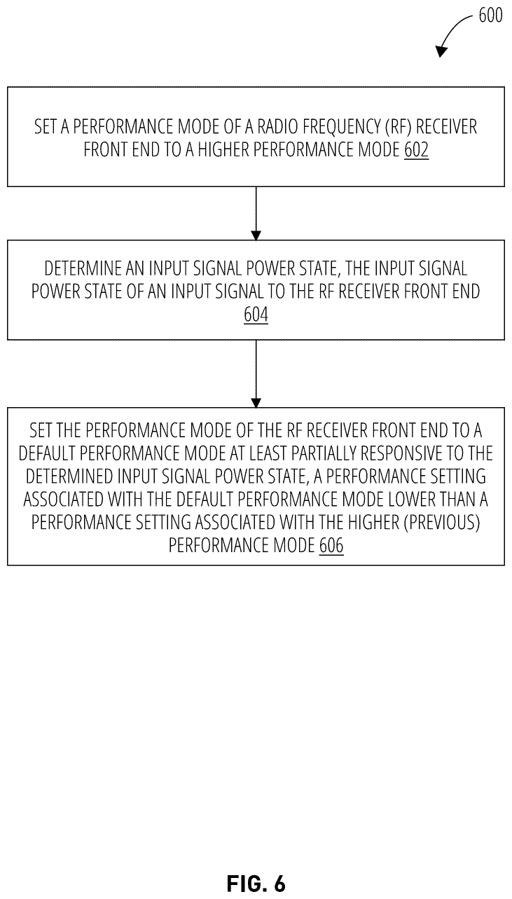

FIG. 6 is a flow diagram depicting a process 600 for operating an RF receiver front end in a default performance mode when an input signal power state indicates changing from a different, higher performance mode, in accordance with one or more examples. Some or a totality of operations of process 500 may be performed, as a non-limiting example, by apparatus 200 or apparatus 300.

Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

In one or more examples, process 600 includes setting a performance mode of a radio frequency (RF) receiver front end to a higher performance mode at operation 602. The higher performance mode may be associated with a higher performance setting than the default performance mode. Other performance modes offered by the RF receiver front end may include a performance mode associated with a lower performance setting than the default performance mode and the higher performance mode.

In one or more examples, process 600 includes determining an input signal power state, the input signal power state of an input signal to the RF receiver front end at operation 604. An input signal may include a target signal, a blocker signal, or both, without limitation.

In one or more examples, process 600 includes setting the performance mode of the RF receiver front end to a default performance mode at least partially responsive to the determined input signal power state, at operation 606. A performance setting associated with the default performance mode lower than the performance setting associated with the higher (previous) performance mode. In this manner, the RF receiver front end only operates at the higher performance mode (higher than the default performance mode) until the input signal power state indicates the higher performance mode is not required (or no longer indicates that the higher performance mode is required) and then changes to the default performance mode. In one or more examples, the performance mode of the RF receiver front end may be set to the default performance mode by asserting a reset signal at an input of a logic circuit (e.g., logic circuit 208 or logic circuit 302, without limitation), by providing a performance setting associated with the default performance setting, or both.

In one or more examples, process 600 may set the performance mode of the RF receiver front end to the default performance mode at least partially responsive to both the determined input signal power state and a determination of no instructions (e.g., an absence of instructions, without limitation) to use a specific performance mode or a performance setting. In one or more examples, process 600 may set the performance mode of the RF receiver front end to the default performance mode regardless of an instruction to utilize the higher performance mode or an indication of an operational condition associated with the higher performance setting.

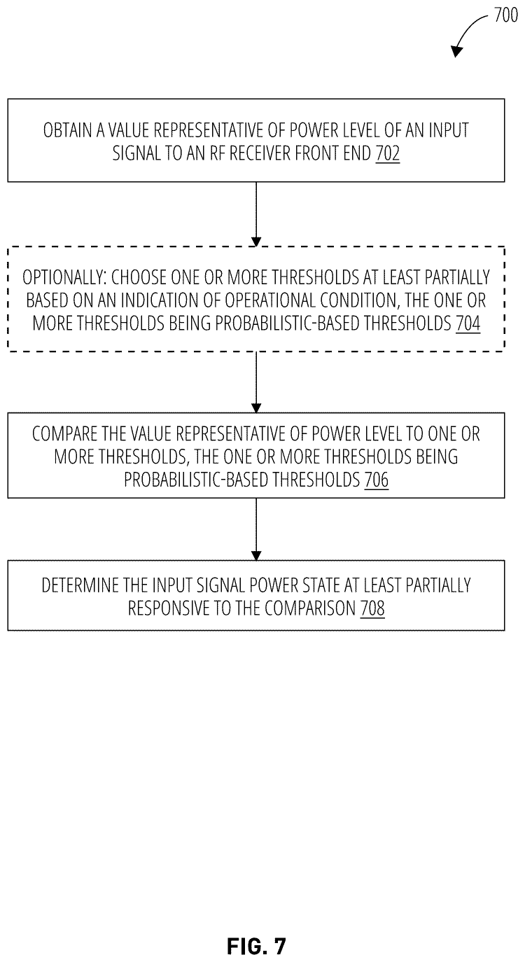

FIG. 7 is a flow diagram depicting a process 700 to determine an input signal power state, the input signal power state of an input signal to an RF receiver front end, in accordance with one more examples. Some or a totality of operations of process 500 may be performed, as a non-limiting example, by apparatus 200 or apparatus 300.

Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence.

In one or more examples, process 700 includes obtaining a value representative of a power level of an input signal to an RF receiver front end at operation 702.

In one or more examples, process 700 includes optionally: choose one or more thresholds at least partially based on an indication of operational condition, the one or more thresholds being probabilistic-based thresholds, at operation 704. In one or more examples, the indication of RF receiver front end mode may be a global setting at an application layer set by a user or set based on the environmental status.

In one or more examples, process 700 includes comparing the value representative of the power level to one or more thresholds, the one or more thresholds being probabilistic-based thresholds at operation 706.

In one or more examples, process 700 includes determining the input signal power state at least partially responsive to the comparison at operation 708.

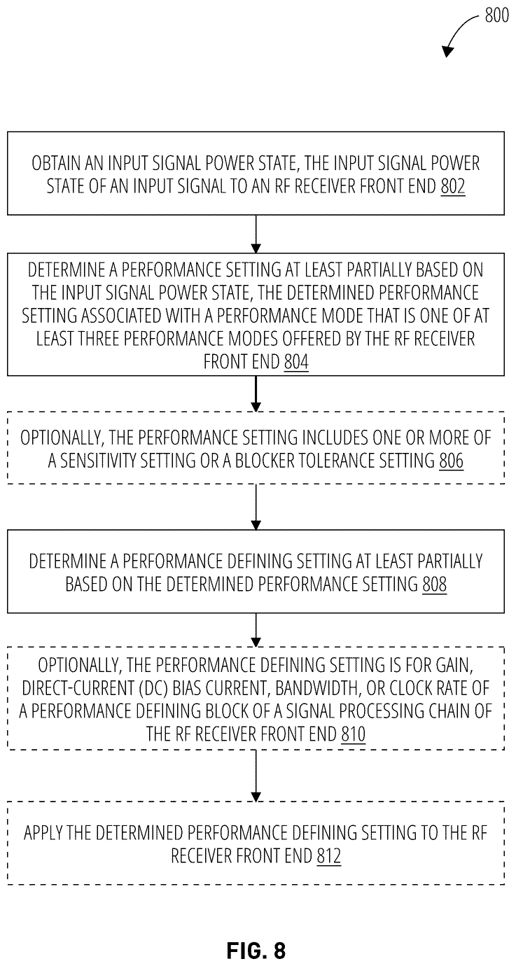

FIG. 8 is a flow diagram depicting a process 800 to set a performance mode of the RF receiver front end to one of at least three distinct performance modes offered by the RF receiver front end at least partially responsive to a determined input signal power state, in accordance with one or more examples. Some or a totality of operations of process 800 may be performed, as a non-limiting example, by apparatus 200 or apparatus 300.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

In one or more examples, process 800 includes obtaining an input signal power state, the input signal power state of an input signal to an RF receiver front end at operation 802.

In one or more examples, process 800 includes determining a performance setting at least partially based on the input signal power state, the determined performance setting associated with a performance mode that is one of at least three performance modes offered by the RF receiver front end at operation 804.

According to one or more examples, process 800 optionally includes that the determined performance setting is a sensitivity setting or blocker tolerance setting, at operation 806.

In one or more examples, process 800 includes determining a performance defining setting at least partially based on the determined performance setting at operation 808. In one or more examples, the performance defining setting includes a sensitivity defining setting, a blocker tolerance defining setting, or both a sensitivity defining setting and a blocker tolerance defining setting.

In one or more examples, process 800 includes optionally the performance defining setting is for gain, direct-current (DC) bias current, filter bandwidth, or clock rate of a performance defining block of a signal processing chain of the RF receiver front end at operation 810.

In one or more examples, process 800 includes applying the determined performance defining setting to the RF receiver front end at operation 812. Applying the determined performance defining setting to the RF receiver front end may include setting respective knobs (e.g., knobs set via fields of a control register such as control register 1100, without limitation) of one or more blocks of a signal processing chain of the RF receiver front end. Setting knobs to the values of the determined performance defining setting sets the performance of the RF receiver front end to the performance setting.

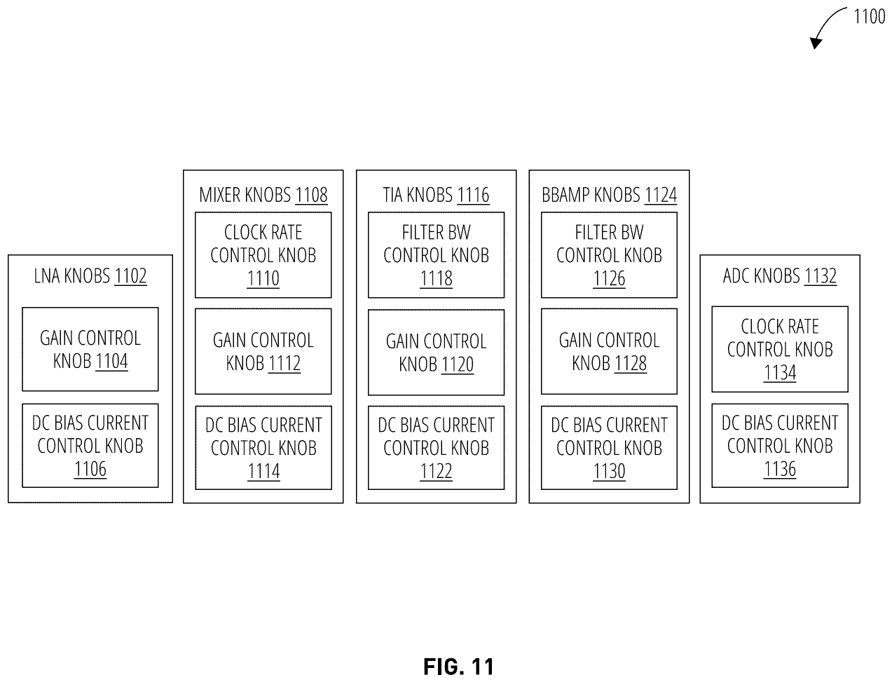

Any suitable technique may be utilized to set the performance modes or performance of a signal processing chain. In one or more examples, performance modes or performance are set via a register (a “control register”) as illustrated by FIG. 11. Values stored in the fields of the control register set specific performance defining characteristics of the signal processing chain.

FIG. 9 is a block diagram depicting a signal processing chain 900 including performance defining blocks (discussed below) that are settable, in accordance with one or more examples. Signal processing chain 900 is a non-limiting example of signal processing chain 202 of FIG. 2.

In one or more examples, respective performance defining blocks of signal processing chain 900 may be directly settable, indirectly settable, or both. If directly settable then bits at a control register (e.g., control register 1100 of FIG. 11, without limitation) directly set parameters of a respective performance defining block. If indirectly settable then directly setting a parameter of another performance defining block via bits of the control register influences the performance defining block.

Examples of parameters of respective blocks of signal processing chain 900 that affect performance include: power consumption, gain, direct current (DC) bias, filter bandwidth, and clock rate.

For each of these performance defining parameters, arc defines a performance value, i.e., the range of filter rejection, amount of gain.

Current consumption is the amount of receiver current consumed by a block. Gain is a measure of how much a block amplifies or attenuates the signal it works on. Bias is the direct-current (DC) operation point current of a block and biases the DC level.

Signal processing chain 900 includes an antenna 902, a low noise amplifier (LNA) 904, a mixer 906, a Baseband Amplifier (BB) 908, a Trans-Impedance Amplifier (TIA) 910, an analog-to-digital converter (ADC) 912, an automatic radio controller (ARC) 914, and a signal level detector 916.

Antenna 902 receives a wireless signal from the air and converts it into an electrical signal, e.g., an analog voltage signal. Antenna 902 captures electromagnetic waves in the air and converts them into an electrical voltages. When the electromagnetic waves in the air correspond to a wireless signal, the electrical voltages generated by antenna 902 are an electrical signal.

LNA 904 amplifies the weak electrical signal received from antenna 902 while adding limited noise to the signal. Amplifying the received signal early in the receiver chain improves the signal-to-noise ratio (SNR) of the received signal. The power consumption of LNA 904 may be set via the gain or bias current, or a combination thereof.

Mixer 906 down converts the frequency of the received signal to a lower frequency for further processing. Mixer 906 is a non-linear device that takes the amplified signal from LNA 904 and mixes it with a local oscillator (LO) signal to produce an intermediate frequency (IF) signal, which may be a current signal, that is a lower frequency than the received signal. Current consumption of the mixer 906 may be set via gain, bias current, or clock rate (or rise and fall time of the clock received at mixer 906), or a combination thereof.

BB 908 provides some additional amplification to the received IF current signal and filters out noise. Current consumption of BB 908 may be set via gain, bias current or filter bandwidth, or a combination thereof.

The TIA 910 is an intermediate frequency (IF) amplifier with built-in low pass filter. TIA 910 converts the IF current signal from the mixer into an IF voltage signal that can be digitized by ADC 912. Current consumption of TIA 910 may be set via gain, bias current, or bandwidth, or a combination thereof. Here, bandwidth determines the range of frequencies the TIA can accurately amplify. If the amount of input current from BB 908 changes rapidly, the ability of TIA 910 to track the changes effectively at least partially depends on its bandwidth.

ADC 912 converts the analog voltage signal from the TIA 910 into a digital signal that can be further processed by digital signal processing (DSP) algorithms. Current consumption of ADC 912 may be set via bias current or bandwidth, or a combination thereof.

Clock sources to mixer 906 and ADC 912 may be the same or different. Different clock sources may have different clock rates. The rise time or fall time of a given clock signal may be set, as a non-limiting example, via a supply voltage level which can be set to set the rise and fall time of a clock signal.

In one or more examples, signal processing chain 900 may include one or more control registers and values in the fields of these control registers may, directly or indirectly, set the parameters of respective blocks utilized by the ARC 914 to set the performance of signal processing chain 900 via performance defining settings 920 in response to performance setting 918.

In some examples, one or more of the sensitivity defining blocks of signal processing chain 900 may offer both a single-ended mode and a differential mode. Differential input mode utilizes more power than single-ended mode, so in some examples, ARC 914 may set respective input modes of the various sensitivity defining blocks of signal processing chain 900 as a performance defining setting 216.

FIG. 10 is a block diagram depicting a signal processing chain 1000 that includes a bypass 1002, in accordance with one or more examples. Bypass 1002 is a circuit to selectively bypass the BB 908. Bypass 1002 provides a further mechanism for ARC 914 to set performance and control power consumption at signal processing chain 1000. If high performance (high sensitivity or interferer rejection (i.e., blocker tolerance)) is not demanded then ARC 914 can bypass BB 908 via performance defining settings 1004 and effectively turn off the BB 908 to reduce power consumption by the BB 908 and signal processing chain 1000 more generally.

FIG. 11 is a block diagram depicting a control register 1100 with fields that are utilized to store values of performance defining settings, in accordance with one or more examples.

Fields of control register 1100 are referred to herein as “knobs,” and the knobs are set by values provided by an ARC (e.g., ARC 914 or automatic radio controller 206, without limitation).

The control register 1100 comprises an LNA knobs 1102, Mixer knobs 1108, TIA knobs 1116, BB amp knobs 1124, and ADC knobs 1132. LNA knobs 1102 includes a gain control knob 1104 and a DC bias current control knob 1106. Mixer knobs 1108 includes a Clock rate control knob 1110, a gain control knob 1112, and a DC bias current control knob 1114. TIA knobs 1116 include a Filter BW control knob 1118, a gain control knob 1120, and a DC bias current control knob 1122. BBamp knobs 1124 include a Filter BW control knob 1126, a gain control knob 1128, and a DC bias current control knob 1130. ADC knobs 1132 includes a Clock rate control knob 1134 and a DC bias current control knob 1136.

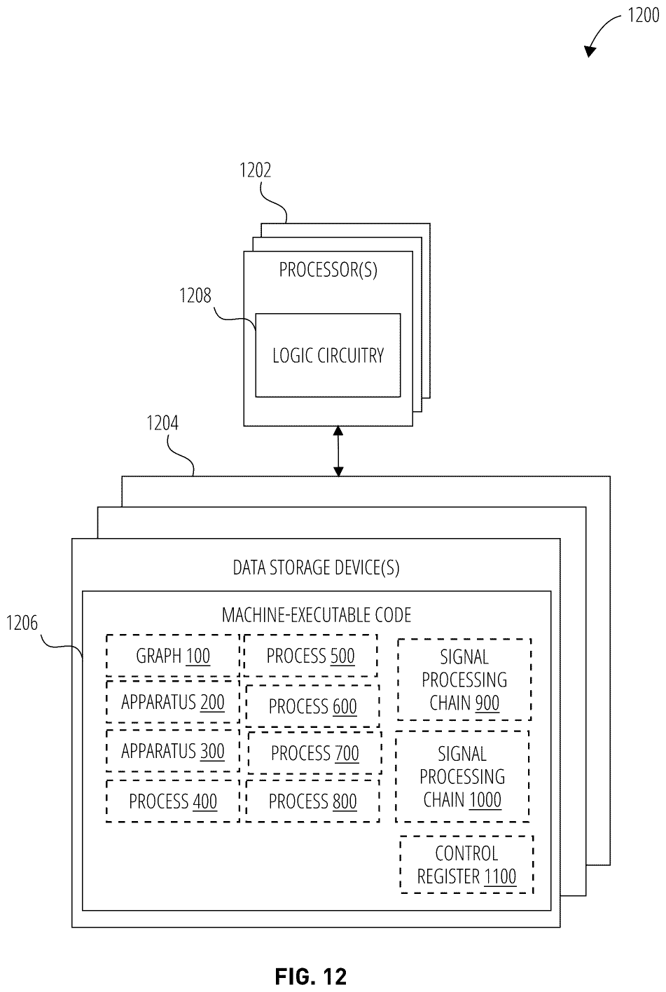

It will be appreciated by those of ordinary skill in the art that functional elements of examples disclosed herein (e.g., functions, operations, acts, processes, or methods) may be implemented in any suitable hardware, software, firmware, or combinations thereof. FIG. 12 illustrates non-limiting examples of implementations of functional elements disclosed herein. In some examples, some or all portions of the functional elements disclosed herein may be performed by hardware specially configured for carrying out the functional elements.

FIG. 12 is a block diagram of a circuitry 1200 that, in some examples, may be used to implement various functions, operations, acts, processes, or methods disclosed herein. The circuitry 1200 includes one or more processors 1202 (sometimes referred to herein as “processors 1202”) operably coupled to one or more data storage devices 1204 (sometimes referred to herein as “storage 1204”). The storage 1204 includes machine-executable code 1206 stored thereon and the processors 1202 include logic circuitry 1208. The machine-executable code 1206 information describes functional elements that may be implemented by (e.g., performed by) the logic circuitry 1208. The logic circuitry 1208 is adapted to implement (e.g., perform) the functional elements described by the machine-executable code 1206. The circuitry 1200, when executing the functional elements described by the machine-executable code 1206, should be considered as special purpose hardware configured for carrying out functional elements disclosed herein. In some examples, the processors 1202 may be configured to perform the functional elements described by the machine-executable code 1206 sequentially, concurrently (e.g., on one or more different hardware platforms), or in one or more parallel process streams.

When implemented by logic circuitry 1208 of the processors 1202, the machine-executable code 1206 is configured to adapt the processors 1202 to perform operations of examples for setting performance of an RF receiver front end discussed herein. By way of non-limiting example, the machine-executable code 1206 may be configured to adapt the processors 1202 to perform some or a totality of operations of one or more of: process 400, process 500, process 600, process 700, or process 800.

Also by way of non-limiting example, the machine-executable code 1206 may be configured to adapt the processors 1202 to perform some or a totality of features, functions, or operations disclosed herein for one or more of: apparatus 200, including signal processing chain 202, automatic radio controller 206 and logic circuit 208; apparatus 300, including logic circuit 302; input signal power state definitions 304, performance setting definitions 308, sensitivity setting definitions 314, and blocker tolerance setting definitions 316; signal processing chain 900 including antenna 902, LNA 904, mixer 906, BB 908, TIA 910, ADC 912, or ARC 914; signal processing chain 1000 including bypass 1002; control register 1100.

The processors 1202 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1206 (e.g., software code, firmware code, hardware descriptions) related to examples of the present disclosure. It is noted that a general-purpose processor (may also be referred to herein as a host processor or simply a host) may be a microprocessor, but in the alternative, the processors 1202 may include any conventional processor, controller, microcontroller, or state machine. The processors 1202 may also be implemented as a combination of computing devices, such as a combination of a DSP and a microprocessor, a plurality of microprocessors, one or more microprocessors in conjunction with a DSP core, or any other such configuration.

In some examples, the storage 1204 includes volatile data storage (e.g., random-access memory (RAM)), non-volatile data storage (e.g., Flash memory, a hard disc drive, a solid state drive, erasable programmable read-only memory (EPROM), without limitation). In some examples, the processors 1202 and the storage 1204 may be implemented into a single device (e.g., a semiconductor device product, a system on chip (SOC), without limitation). In some examples, the processors 1202 and the storage 1204 may be implemented into separate devices.

In some examples, the machine-executable code 1206 may include computer-readable instructions (e.g., software code, firmware code). By way of non-limiting example, the computer-readable instructions may be stored by the storage 1204, accessed directly by the processors 1202, and executed by the processors 1202 using at least the logic circuitry 1208. Also by way of non-limiting example, the computer-readable instructions may be stored on the storage 1204, transferred to a memory device (not shown) for execution, and executed by the processors 1202 using at least the logic circuitry 1208. Accordingly, in some examples, the logic circuitry 1208 includes electrically configurable logic circuitry 1208.

In some examples, the machine-executable code 1206 may describe hardware (e.g., circuitry) to be implemented in the logic circuitry 1208 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1208 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine-executable code 1206 may include an HDL, an RTL, a GL description, a mask level description, other hardware description, or any combination thereof.

In examples where the machine-executable code 1206 includes a hardware description (at any level of abstraction), a system (not shown, but including the storage 1204) may be configured to implement the hardware description described by the machine-executable code 1206. By way of non-limiting example, the processors 1202 may include a programmable logic device (e.g., an FPGA or a PLC) and the logic circuitry 1208 may be electrically controlled to implement circuitry corresponding to the hardware description into the logic circuitry 1208. Also by way of non-limiting example, the logic circuitry 1208 may include hard-wired logic manufactured by a manufacturing system (not shown, but including the storage 1204) according to the hardware description of the machine-executable code 1206.

Regardless of whether the machine-executable code 1206 includes computer-readable instructions or a hardware description, the logic circuitry 1208 is adapted to perform the functional elements described by the machine-executable code 1206 when implementing the functional elements of the machine-executable code 1206. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: an RF receiver front end that offers at least three distinct performance modes; a logic circuit to specify a performance mode of the three distinct performance modes at least partially responsive to an input signal power state; and an automatic radio controller to set a performance mode of the RF receiver front end to the specified one of the three distinct performance modes.

Example 2: The apparatus according to Example 1, wherein the distinct performance modes include different sensitivity settings and blocker tolerance settings.

Example 3: The apparatus according to Examples 1 and 2, wherein the RF receiver front end offers one or more further distinct performance modes, and wherein respective performance associated with the one or more further distinct performance modes are between the highest sensitivity and the lowest sensitivity.

Example 4: The apparatus according to one or more of Example 1 to 3, wherein the logic circuit to: obtain a value representative of a power level of an input signal to the RF receiver front end; compare the value representative of the power level of the input signal to one or more thresholds, the one or more thresholds being probabilistic-based thresholds; and determine the input signal power state at least partially responsive to the comparison.

Example 5: The apparatus according to one or more of Examples 1 to 4, wherein the logic circuit to: choose the one or more thresholds at least partially based on an indication of RF receiver front end mode.

Example 6: The apparatus according to one or more of Examples 1 to 5, wherein the logic circuit to: determine a performance setting at least partially based on the input signal power state, the determined performance setting associated with the performance mode.

Example 7: The apparatus according to one or more of Examples 1 to 6, wherein the performance defining setting is for one or more of a gain, a direct-current bias current, a bandwidth, or a clock rate of a performance defining block of a signal processing chain of the RF receiver front end.

Example 8: The apparatus according to one or more of Examples 1 to 7, comprising an automatic radio controller to: determine a performance defining setting at least partially based on the determined performance setting; and apply the determined performance defining setting to the RF receiver front end.

Example 9: The apparatus according to one or more of Examples 1 to 8, wherein the logic circuit includes: input signal power state definitions that include one or more thresholds associated with input signal power states; and performance setting definitions that includes one or more performance settings associated with input signal power states.

Example 10: The apparatus according to one or more of Examples 1 to 9, wherein the RF receiver front end includes a signal processing chain comprising: a low-noise amplifier; a mixer; a baseband amplifier; an intermediate frequency (IF) amplifier with built-in low pass filter; and an analog-to-digital converter (ADC).

Example 11: The apparatus according to one or more of Examples to 10, comprising: a circuit to selectively bypass the baseband amplifier.

Example 12: The apparatus according to one or more of Examples 1 to 11, comprising: an automatic radio controller to dynamically set one or more parameters of power-defining blocks of the RF receiver front end within one of the at least three distinct performance modes.

Example 13: The apparatus according to one or more of Examples 1 to 12, wherein the logic circuit to specify a default performance mode, a performance setting associated with the default performance mode lower than a performance setting associated with the specified one of the three distinct performance modes.

Example 14: A method, comprising: determining a power state of an input signal to an RF receiver front end; and setting a performance mode of the RF receiver front end to one of at least three distinct performance modes offered by the RF receiver front end at least partially responsive to the determined power state of the input signal.

Example 15: The method according to Example 14, comprising: obtaining a value representative of a power level of the input signal to the RF receiver front end; comparing the value representative of the power level of the input signal to the RF receiver front end to one or more thresholds, the one or more thresholds being probabilistic-based thresholds; and determining the power state of the input signal at least partially responsive to the comparison.

Example 16: The method according to one or more of Examples 14 and 15, comprising: choosing the one or more thresholds at least partially based on an indication of RF receiver front end mode, the one or more thresholds being probabilistic-based thresholds.

Example 17: The method according to one or more of Examples 14 to 16, comprising: determining a performance setting at least partially based on the power state of the input signal, the determined performance setting associated with one of at least three performance modes offered by the RF receiver front end; and determining a performance defining setting at least partially based on the determined performance setting.

Example 18: The method according to one or more of Examples 14 to 17, wherein the performance defining setting is for gain, direct-current bias current, bandwidth, or clock rate of a performance block of a signal processing chain of the RF receiver front end.

Example 19: The method according to one or more of Examples 14 to 18, comprising: applying the determined performance defining setting to the RF receiver front end.

Example 20: The method according to one or more of Examples 14 to 19, wherein the determined performance setting includes one or more of a sensitivity setting or a blocker tolerance setting.

Example 21: The method according to one or more of Examples 14 to 20, comprising: setting the performance mode of the RF receiver front end to a default performance mode, a performance setting associated with the default performance mode lower than a performance setting associated with the set one of at least three distinct performance modes offered by the RF receiver front end.

Example 22: The method according to one or more of Examples 14 to 21, wherein the setting the performance mode of the RF receiver front end to the default performance mode comprises: setting the performance mode of the RF receiver front end to the default performance mode at least partially responsive to an indication of: a power-on, a power-on reset, or a reset.

Example 23: The method according to one or more of Examples 14 to 22, wherein the set one of at least three distinct performance modes offered by the RF receiver front end is a default performance mode.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
an RF receiver front end that offers at least three distinct performance modes;
a logic circuit to specify a performance mode of the three distinct performance modes at least partially responsive to an input signal power state; and
an automatic radio controller to set a performance mode of the RF receiver front end to the specified one of the three distinct performance modes.

2. The apparatus of claim 1, wherein the distinct performance modes include different sensitivity settings and blocker tolerance settings.

3. The apparatus of claim 1, wherein the RF receiver front end offers one or more further distinct performance modes, and wherein respective performance associated with the one or more further distinct performance modes are between the highest sensitivity and the lowest sensitivity.

4. The apparatus of claim 1, wherein the logic circuit to:
obtain a value representative of a power level of an input signal to the RF receiver front end;
compare the value representative of the power level of the input signal to one or more thresholds, the one or more thresholds being probabilistic-based thresholds; and
determine the input signal power state at least partially responsive to the comparison.

5. The apparatus of claim 4, wherein the logic circuit to:
choose the one or more thresholds at least partially based on an indication of RF receiver front end mode.

6. The apparatus of claim 4, wherein the logic circuit to:
determine a performance setting at least partially based on the input signal power state, the determined performance setting associated with the performance mode.

7. The apparatus of claim 6, wherein the performance defining setting is for one or more of a gain, a direct-current bias current, a bandwidth, or a clock rate of a performance defining block of a signal processing chain of the RF receiver front end.

8. The apparatus of claim 6, comprising an automatic radio controller to:
determine a performance defining setting at least partially based on the determined performance setting; and
apply the determined performance defining setting to the RF receiver front end.

9. The apparatus of claim 1, wherein the logic circuit includes:
input signal power state definitions that include one or more thresholds associated with input signal power states; and
performance setting definitions that includes one or more performance settings associated with input signal power states.

10. The apparatus of claim 1, wherein the RF receiver front end includes a signal processing chain comprising:
a low-noise amplifier;
a mixer;
a baseband amplifier;
an intermediate frequency (IF) amplifier with built-in low pass filter; and
an analog-to-digital converter (ADC).

11. The apparatus of claim 10, comprising: a circuit to selectively bypass the baseband amplifier.

12. The apparatus of claim 1, comprising:
an automatic radio controller to dynamically set one or more parameters of power-defining blocks of the RF receiver front end within one of the at least three distinct performance modes.

13. The apparatus of claim 1, wherein the logic circuit to specify a default performance mode, a performance setting associated with the default performance mode lower than a performance setting associated with the specified one of the three distinct performance modes.

14. A method, comprising:
determining a power state of an input signal to an RF receiver front end; and
setting a performance mode of the RF receiver front end to one of at least three distinct performance modes offered by the RF receiver front end at least partially responsive to the determined power state of the input signal.

15. The method of claim 14, comprising:
obtaining a value representative of a power level of the input signal to the RF receiver front end;
comparing the value representative of the power level of the input signal to the RF receiver front end to one or more thresholds, the one or more thresholds being probabilistic-based thresholds; and
determining the power state of the input signal at least partially responsive to the comparison.

16. The method of claim 15, comprising:
choosing the one or more thresholds at least partially based on an indication of RF receiver front end mode, the one or more thresholds being probabilistic-based thresholds.

17. The method of claim 14, comprising:
determining a performance setting at least partially based on the power state of the input signal, the determined performance setting associated with one of at least three performance modes offered by the RF receiver front end; and
determining a performance defining setting at least partially based on the determined performance setting.

18. The method of claim 17, wherein the performance defining setting is for gain, direct-current bias current, bandwidth, or clock rate of a performance block of a signal processing chain of the RF receiver front end.

19. The method of claim 17, comprising:
applying the determined performance defining setting to the RF receiver front end.

20. The method of claim 17, wherein the determined performance setting includes one or more of a sensitivity setting or a blocker tolerance setting.

21. The method of claim 14, comprising:
setting the performance mode of the RF receiver front end to a default performance mode, a performance setting associated with the default performance mode lower than a performance setting associated with the set one of at least three distinct performance modes offered by the RF receiver front end.

22. The method of claim 21, wherein the setting the performance mode of the RF receiver front end to the default performance mode comprises:
setting the performance mode of the RF receiver front end to the default performance mode at least partially responsive to an indication of: a power-on, a power-on reset, or a reset.

23. The method of claim 14, wherein the set one of at least three distinct performance modes offered by the RF receiver front end is a default performance mode.
